(19) United States
(12) Patent Application Publication
(10) Pub. No.: US 2024/0338457 A1
(43) Pub. Date: Oct. 10, 2024

(54) SYSTEM AND METHOD FOR IDENTIFYING, ASSESSING, EVALUATING AND MANAGING RISKS OF SOFTWARE UPDATES

(71) Applicant: Gopal N. Krishnan, Austin, TX (US)

(72) Inventor: Gopal N. Krishnan, Austin, TX (US)

(21) Appl. No.: 18/625,296

(22) Filed: Apr. 3, 2024

Related U.S. Application Data
(60) Provisional application No. 63/457,140, filed on Apr. 5, 2023.

(51) Int. Cl. G06F 21/57

(52) U.S. Cl. CPC G06F 21/577; G06F 21/572; G06F 2221/033

(57) ABSTRACT

A system and method enables an organization to assess the risk to a software system's capabilities due to inclusion of changes based on the sentiments expressed about the changes in written and spoken forums, release notes, meeting call transcripts and collaborative messaging systems. Embodiments of systems and methods monitor sources over time to collect information relating to software releases and components of the software releases. The collected information is analyzed and contextualized to derive sentiments relating to the software release. A sentiment score can be calculated based on the analyzed and contextualized information indicating a level of risk or confidence relating to the software release.

### CROSS-REFERENCE TO RELATED APPLICATION(S)

This application claims a benefit of priority under 35 U.S.C. § 119 (e) from U.S. Provisional Application No. 63/457,140, filed Apr. 5, 2023, entitled “A SYSTEM AND METHOD FOR IDENTIFYING, ASSESSING, EVALUATING AND MANAGING RISKS OF SOFTWARE UPDATES,” which is fully incorporated by reference herein for all purposes.

### TECHNICAL FIELD

This disclosure relates generally to software releases and updates. More particularly, embodiments relate to the field of assessing and managing risks relating to software updates and releases.

### BACKGROUND

In the field of software development, software system outages are a relatively common problem. Behind every system outage there was likely a recent (e.g., within the last 24-48 hours) update. The software system can be a software application, Software-as-a-Service (SaaS), Platform-as-a-Service (PaaS), etc., built (offered) by an organization and consumed by the organization, its customers, or both.

Today's software systems are complex, and are typically stitched together using software services and components sourced from 3rd parties, OpenSource, or even individuals outside the organization. Software systems typically require frequent updates (changes) for security fixes, bug fixes, scalability, and for enhancing functionalities incrementally or stepwise. The frequency of updates can be as short as a day (for 0-day, 1-day security vulnerabilities) or it can be a defined interval of days, weeks or months.

Mission-critical software systems' outage or malfunction during or after an update can result in reputational, financial, regulatory and even national security impacts. For example, a recent FAA systems outage grounded all flights in the US for a few hours. Business imperatives, time, and resource constraints often do not allow a software system to be tested extensively after an update in order to prevent or minimize outage risks.

There is therefore a need for systems and methods for identifying, assessing, evaluating and managing risks of software updates and releases.

### SUMMARY

Systems and methods for evaluating risks associated with a software release are described that, in some embodiments, includes a processor; a data store; and a non-transitory computer readable medium storing instructions translatable by the processor, the instructions when translated by the processor perform: monitoring a plurality of sources over time to collect information relating to the software release and components of the software release, wherein each of the sources are related to the software release or components of the software release; analyzing the collected information to derive context of the information as it relates to changes incorporated into the software release; deriving the sentiments relating to the software release or to components of the software release; apply weights to the sentiment score to reflect the importance of change to the overall functioning of the software system; periodically calculating cumulative sentiment scores over time for the software release; and monitoring the calculated sentiment scores over time to evaluate risks associated with the software release.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a conceptual view of a system and method for assessing the risks of an update to a software system using sentiment score of the changes and the release.

FIG. 2 depicts an example of a structure of a software system.

FIG. 3 depicts a functional diagram of a system and method for assessing the risks of an update to a software system.

FIG. 4 depicts a diagram illustrating a sentiment analysis model enhancement.

FIG. 5 depicts a diagram illustrating an example of a range of sentiment scores.

FIG. 6 depicts a table of exemplary explicit and implicit context determination approaches with respect to a variety of information sources.

FIG. 7 depicts a diagram of an initial configuration process for a method for assessing the risks of an update to a software system.

FIG. 8 depicts a process diagram of an exemplary run-time view of a method for assessing the risks of an update to a software system.

FIG. 9 is a process diagram illustrating an exemplary process for assessing the risks of an update to a software system.

FIG. 10A depicts equations representing weighted sentiment of a change item CI.

FIG. 10B depicts a chart illustrating the computation of cumulative sentiment score and exemplary sentiment scores over time.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Throughout this description, various commercially available/opensource/proprietary/etc. products/services are referenced with respect to various aspects of the invention. Note that specific references to commercially available, opensource, proprietary, etc., products and services are provided merely as examples, and other similar or equivalent commercially available or proprietary products/services may also be used.

Generally, the disclosed systems and methods described below enable an organization to assess the risk to a software system's capabilities due to inclusion of a change (or changes) based on the sentiments expressed about the change(s) in written and spoken forums, release notes, meeting call transcripts and collaborative messaging systems such as Slack, etc. In some embodiments, a plurality of sources are monitored over time to collect information relating to software releases and components of the releases. The collected information is analyzed and contextualized to derive sentiments relating to the software release and contextualized to derive sentiments related to each change or changes to components and to the software release.

In some embodiments, a sentiment score (or scores) is calculated based on the analyzed and contextualized information. The sentiment score indicates the level of confidence relating to a software release or relating to components being changed. The score and the explanations behind it provide confidence-building or confidence-diminishing insights of the software change by examining various aspects of it using a combination of traditional and artificial intelligence (AI) techniques relating to components that changed which are included in the software release and the software release itself.

Based on the sentiment score, as well as trends derived from the risk scores over time, an organization can, among other items, plan downstream activities to deploy the release in production, plan additional reviews, testing or other preventative measures to minimize risk.

There is significant increase in the dependency on software systems and services that impact an organization, industry, or total population. Changes and updates have also increased. Assessing risk of an update whether it has one or more changes in a formal way is desirable to reduce risks. The concepts in the disclosed system and methods discussed herein enables a way to surface sentiments relating to the changes in order to evaluate the risk.

Further integrations of the assessments into various Software Development Lifecycle (SDLC) management systems can provide mechanisms to address, enumerate and manage updates for risks and compliance audits.

Typical software systems are “assembled” using “components,” which may include code fragments, services, capabilities, etc., available from OpenSource, 3rd parties and individuals. The “glue” code and any special processing code are typically developed by the individuals offering the Software System. The percentage of code written by the software system provider varies. However, in the past decade, the use of 3rd Party and OpenSource components has been growing as the availability has increased and the practice has been accepted widely. In addition, the use of 3rd Party and OpenSource components is expected to grow rapidly to accelerate development and keep up with the demands of the business. Software engineers and programmers import/include code and libraries based on the “face value” of the capability provided by it, namely the input and output parameters and the description. Typically there is little or no investigation performed on the authors of the imported code, their coding practices, their testing methods, etc., other than the implicit trust of the individual or the organization. The behaviors of the imported components in the context of the software systems in which it is used are typically not known or not taken into account by the author of the component during the design, development and testing of the components. In addition, when the components are updated, there is less visibility to cascading dependencies and the quality of testing.

Many software systems are designed to be controlled by “configuration” settings. Changes to the configurations can impact the behavior of the Software Systems and the components used to build it.

One other issue relating to software releases is that the rate and pace of changes are neither predictable nor controllable. While functionality updates and some bug fixes in the code sourced internally (meaning, written by the individuals in the organization providing the Software System) can be planned, updates and fixes for the components sourced externally do not lend themselves to planning. Such components may also contain components sourced from sources external to their component provider, and the dependencies cascade beyond the known sources of components. For example, sudden updates can happen in the context of security vulnerabilities found and severe enough to be fixed within hours. The diverse and cascading number of sources, lack of visibility to their change processes/timetables, and the urgency of the fixes for security reasons compresses the time to build and test software Systems.

Today's workforce and development processes leave a lot of room for errors. In the software and information technology industry, decades of outsourcing, offshoring, increased use of contractors and remote working have enabled organizations to scale up and gain access to talents worldwide. The geographical diversity of the software workforce, i.e., in the office, remote, work from home, and hybrid working styles, etc., provides less opportunity to have face-to-face group or individual meetings. It is challenging and time consuming to assess the individuals' tone, body language, completeness of the information they provide, with respect to the updates they are making. These difficulties are further compounded by the diversity of academic, training, experience, skill, cultural, and linguistic aspects of individuals and organizations.

Critical information such as the up and down dependencies of the changes, how the change was tested, etc., is difficult to come by even after quizzing/probing the individuals. The decision makers are left with just comments made on trouble tickets, bug tracking software such as Jira, or verbal comments made in meetings. The volume can be high and the details may not be deep.

The practice of “Pull Requests” provides a mechanism for an experienced individual to review the changes being made by another individual in the team. However, the volume and the urgency do not provide adequate time for the reviewer to pass judgement or assess risks. “Agile methodology” enables build out of capabilities in an incremental fashion. However, this contributes to frequent updates of software. In addition, it also creates a forgiving environment for engineers where not finishing a functionality fully, not testing a functionality deeply and not testing the new/updated functionality in conjunction with existing capabilities are accepted as par for the course. The architectural and design decisions are often changed mid-stream requiring changes to capabilities completed in earlier releases and invalidating the test cases/tests. Practices such as leaving behind technical debts, testing only happy paths and bypassing edge cases also contribute to large unknowns in the behavior of the software system and add to the risks when releasing and updating software.

When changes to software are required, there is less opportunity or time to assess the impact of a change prior to making that change, due to the tactical nature of bug fixes and unknowns in the imported components and libraries. Decisions made for incorporating changes are often done at the face value and not with in-depth discussion with the hope of uncovering issues during quality assurance testing. Test coverage is often questionable as the scope of testing may not explicitly cover 3rd party dependencies.

The CI/CD (continuous integration/continuous deployment) methodology is the de facto best practice in many software organizations. The build process (scripts) pulls in updates and changes automatically and relies on automated testing to detect incompatibilities or problems in the changed components. Due to inadequate coverage of automated testing, some incompatibilities and/or problems may not be identified until the updated version of the software system goes into production.

As discussed above, there are various risks involved with software releases. Less rigor in risk Identification/assessment of software changes results in releases with a higher risk of outage. With a narrow and tactical view of getting a software fix or an update into production, the decision makers are often as myopic as the originators or sponsors of the change. The decision makers who approve the changes for production deployment rely on the evidence presented to them, which are primarily the results of testing and the open bugs. Typically, there is little or no discussion of what all went into the update and if there are any hidden or implicit risks. Also, software release meetings are typically done remotely, or sign-offs obtained asynchronously through emails or through the tickets in the bug/issue tracking system. As a result, the decision makers have less information to view/assess risks. Even if some concerns surface, as the momentum builds up for a release, the decision makers are less inclined to “stop the train (of release)” and more likely to deploy something that could potentially cause a serious outage.

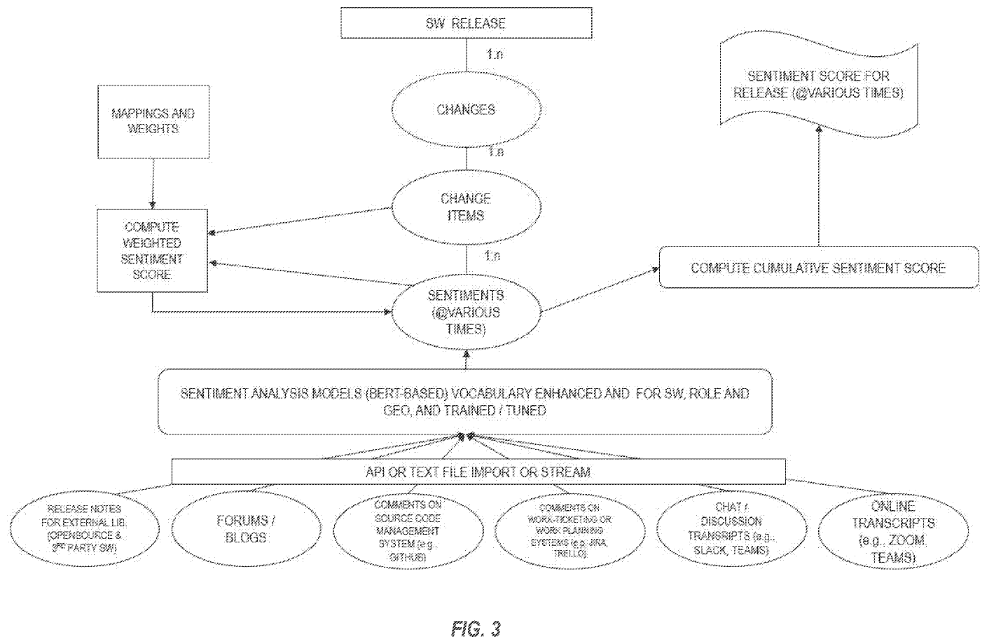

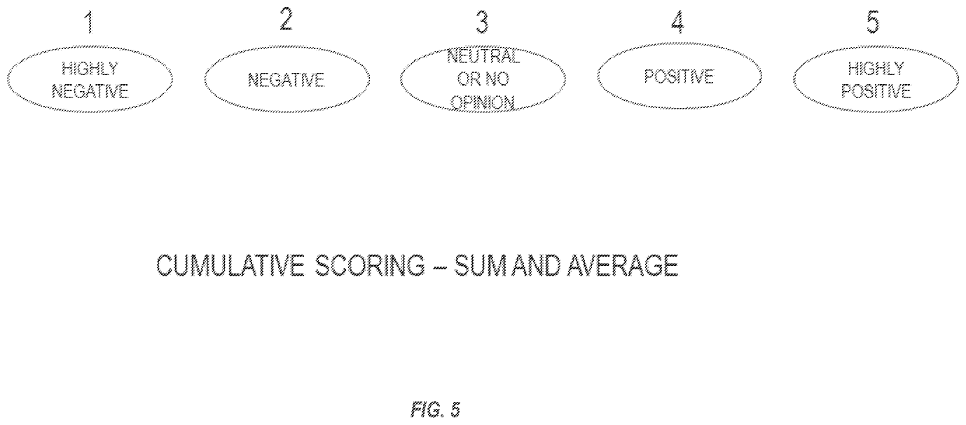

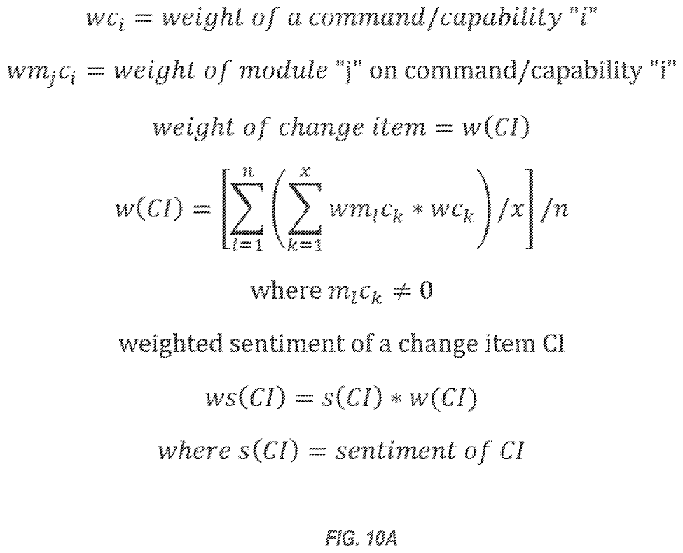

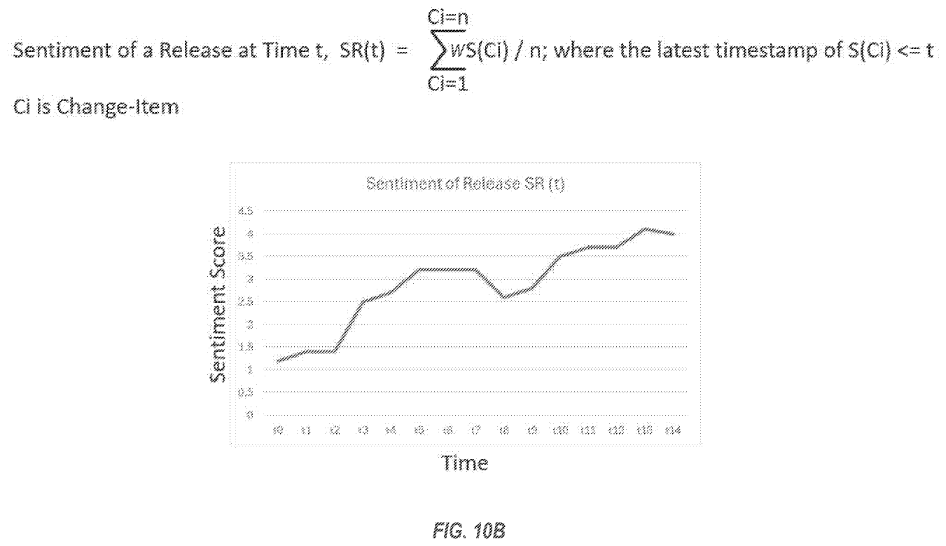

As mentioned above, in some embodiments, systems and methods provide a mechanism in the form of a sentiment score to surface the risk or confidence level in a software release, and make it visible to decision makers with relevant supporting information on how the score was computed. Such a risk assessment can be tailorable to the organization and application, and contextualized to the capabilities. This enables the testing and or investigation to be capabilities-based and relatable to the decision makers, as opposed to a granular/component-based view of risks. FIG. 5 illustrates one non-exhaustive example of a range of sentiment scores, including “Highly Negative,” “Negative,” “Neutral or No Opinion,” “Positive,” and “Highly Positive.” Of course sentiment scores can be displayed in labeled in various manners, as one skilled in the art would understand. Note that cumulative scoring and average relates to the “Compute weighted sentiment score” box in FIG. 3, and is related to the sentiment mathematical formula shown in FIGS. 10A-10B.

While “zero defect” in commercial software systems is unachievable given the cost/effort/time, there is plenty of opportunity to apply Artificial Intelligence, Machine Learning and Natural Language Processing (AI/ML/NLP) techniques, Large Language Models (LLM) and generative AI such as ChatGPT to assess risks in a release and initiate mitigation steps.

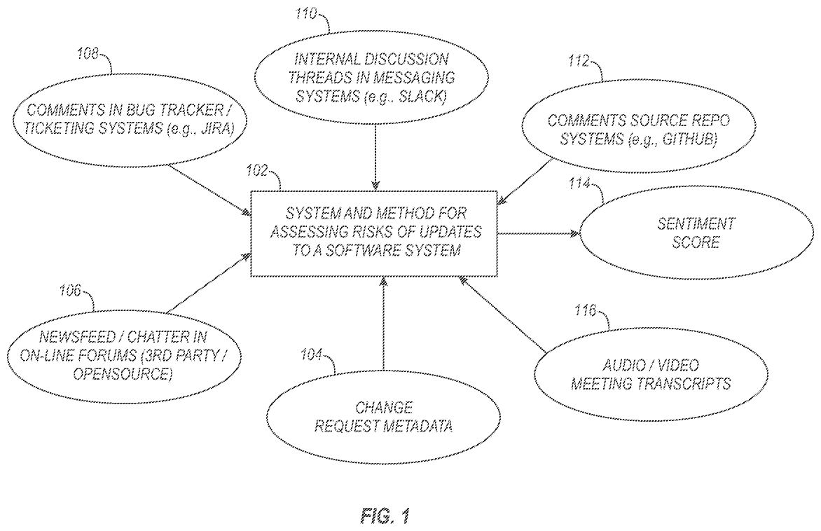

FIG. 1 depicts a conceptual view of a system and method for assessing the risks of an update to a software system by examining the change(s) incorporated into the update. In some embodiments, the system uses information from the provider of the software system and augments it with information available to it from external/internal sources such as release notes, blogs, discussion threads, bug tracking systems etc. Using AI, ML and NLP algorithms, system evaluates the risk of an update and surfaces the risk through a single sentiment score. The system also provides explanations for the score and feeds the insights into a dashboard.

As discussed above, the system 102 monitors and/or receives information a plurality sources. In the example of FIG. 1, the system 102 monitors: change request metadata 104; newsfeed, chatter, forums (3rd party/OpenSource) 106; comments/in GitHub (or other source repository); internal Slack channel/Teams discussion threads 110; audio/video meeting transcripts 116; comments in Jira (or other bug tracker/ticketing system) 112; and sentiment score 114. The system 102 can monitor numerous other sources as well, as one skilled in the art would understand. As discussed in detail below, the system analyzes and contextualizes the information collected from the various sources and derives a sentiment score 114.

Following are several key aspects of a system and method for assessing the risks of an update to a software system. Oher aspects of such a system may also be evident, as one skilled in the art would understand.

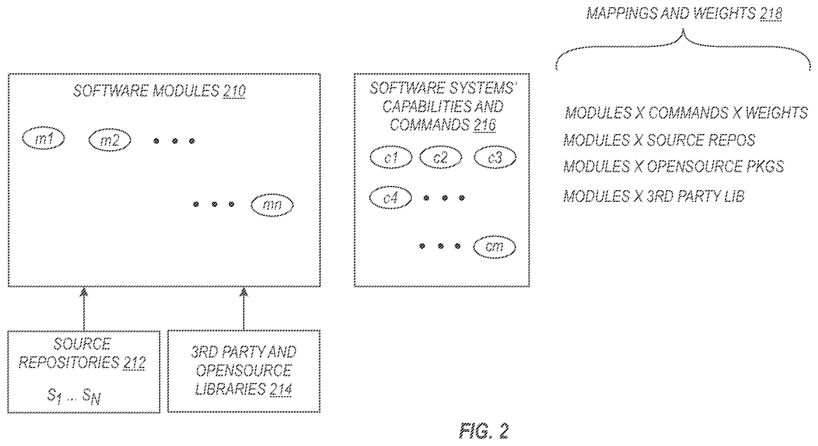

One aspect of a system comprises a mechanism for representing the structural dependencies of various code modules and their weightage of relevance to a software system. FIG. 2 illustrates an example of a structure of a software system. In the example of FIG. 2 shows n software modules 210, source repositories 212, and third party OpenSource libraries 214. FIG. 2 shows m software system capabilities 216, as well as mappings 218. The information related to the entities and relationships (mappings 218) illustrated in FIG. 2 can be entered manually or inferred through automated means (e.g., code scanning, etc.) through commercially available or custom developed utilities. This information is continuously or periodically updated in order to keep it up to date. In addition to the relationship, the strength or the weight of each relationship can be specified to indicate the importance or the degree of dependency. In some embodiments, the weight can be a number from 0.0 to 1.0 or can be a qualitative, such as “Hi,” “Lo,” “Medium.”

This information can be used when assessing the impact and the risks of a software change(s). The mapping to commands or capabilities provides another mechanism to assess the areas of the product that may be impacted by a change to a component or library or a source file from the end-user's usability perspective which is usually stated as missing or malfunctioning command or capability. The importance or weight of a command or capability to the user can be defined in the context of that capability and its mapping to a source file or an OpenSource library or a 3rd Party component. Based on a change item, the mappings and weights help determine the potential impact of a failure in a capability should the change indicated by the change item fails when released. The sentiment score of a change item is updated based on the importance of the capability impacted and used in assessing the risk for the release. First, using the change item, the impacted module is determined using the source repository (or library) mapping to modules. Second, the mapping between modules and command/capability is used to determine the capability/command that has a potential impact should the change fail. The weight of this relationship and the weight (importance) of this capability/command are multiplied to arrive at the weight factor that is used in updating the sentiment scores of change items. The mapping and the weights are expressed in simple two dimensional matrices where the cells contain a score of 0.0-1.0. The importance (weight) of a command/capability to the end user is represented in a simple 2 column table where each command/capability is a row (1st column) and the corresponding importance is expressed as a number between 0.0 and 1.0. (Lo to Hi). The importance (weight) of a software module to a command(s)/capability (ies) is also represented in a two dimensional matrix, where each row corresponds to a module, and each column (column 2) onwards corresponds to a command or capability. The value in each cell of the matrix indicates the weight score (0.0-1.0).

Another aspect of a system comprises a mechanism for assessing the quality or aspects of changes based on the “release notes.” It is a common practice for 3rd party and OpenSource components to be released with “Release Notes,” i.e., a textual description of the changes that went into the release. Release notes typically include the reasons (e.g., bug fix, increased functionality, etc.) for the updates, any caveats or differences in behavior, and any open/known bugs, etc. In order to assess the impact of changes in 3rd Party and OpenSource components, in some examples, the release notes can be machine read, understood, and then interpreted in the context of the software system's capabilities. Using AI, ML and/or NLP techniques, the changes can be classified, and based on the weights/importance, the impact and risks can be assessed.

Another aspect of a system comprises a mechanism for gathering and analyzing “chatter” relating to a software change. Engineers and other stakeholders involved in defining, designing, and incorporating the software change(s) typically make their views known formally in the bug tracking system (e.g., Jira, etc.) and/or other formal design documents (e.g., Confluence pages, etc.) and comments on source management systems (e.g., Github, etc.). There may be equal, if not more, informal comments are made in the chat systems such as “Slack” or “Teams” or in the video/audio meeting sessions (e.g. Zoom) of scrum and other review meetings. For the external components (3rd Party and Opensource) public forums, blogs, X (formerly known as Twitter) and other social media where technical workers congregate or tune into. These informal comments provide a window into the “sentiments” about the change which provides another critical dimension to assess the risk due to a change.

The feeds from these systems and comments made in trouble ticketing, confluence and other systems can be processed using AI, ML and NLP techniques to provide contextual sentiments.

As discussed above, the disclosed systems and methods enable an organization to assess the risk to a software system's capabilities due to inclusion of a change based on the sentiments expressed by individuals about the change. The system and method is configured to evaluate changes to a software module in the context of the following factors (described below) and compute a risk/sentiment score for the release consisting of one or more changes. The evaluation can be performed using historical and current information available from the organization's own systems, public sources, social media, etc. . . . In some embodiments, the evaluation is performed in the context of the module being changed, which could be a “source file” or a “library” or a “configuration file” or any other component whose change contributes to functionality, performance or behavioral changes of the software system.

What is said about the change in conversations among the engineers and/or the stakeholders or by the community of developers and users within the provider organization (or OpenSource and 3Rd Party provider) prior to, during, or after the change was incorporated into the software system is one of the key attributes of change that participates in the computation of risk. We call it “Sentiment” and it is related to a component being changed, change itself, or the release. Sentiment can be inferred from formal notes made in a trouble ticketing or change tracking system (e.g., Jira), the comments made in a source control system (e.g., Github), the release notes, as well as informal forums such as messaging systems (e.g., Slack), Twitter and message boards.

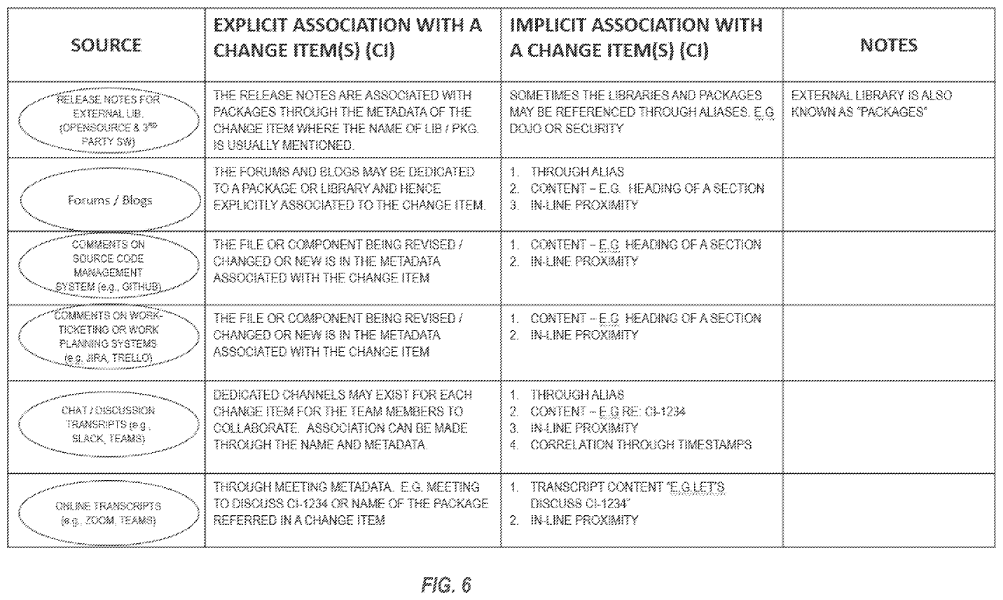

Determining the context (which change or change item or change component) of the comments made in diverse forums is key so that the computed/inferred sentiment can be assigned to the appropriate change, change item or change component. As illustrated in FIG. 6, some of the contexts are explicit and easy to infer from the metadata or description in the trouble ticket, name and/or the members of a messaging group (e.g. Slack channel), title of a recurring on-line meeting (e.g., Zoom call).

Some of the contexts are implicit and need to be inferred through one of the following: Through an Alias reference, In-line mention (written or spoken; e.g. “let's talk about the update of XYZ library” or “let's talk about the bugfix requested in trouble ticket ABC” or “A section heading in a release notes or a release planning document mentioning the change item or change or change component”); Proximity Analysis (through statistical and AI/ML techniques whereby a reasonable assumption can be made of the context based on the text or spoken words relative to other content in the source); and Correlation Through Timestamps. Correlation is needed when opinions and comments are expressed in a parallel medium or source synchronously or near synchronously when a change item/change/release is being discussed in a virtual meeting (e.g., a Zoom call, when a stakeholder pushes for a particular change to be rushed through to release/production, some attendees express their concerns/sentiments among themselves in a group chat w/o explicitly bringing it out in the meeting.)

The exemplary table of FIG. 6 shows a table with various examples of information sources (the first column), explicit associations with a change item (the second column), implicit associations with a change item (the third column), and notes (the fourth column). Various other examples are also possible, as one skilled in the art would understand.

Using AI (NLP, Neural net or other machine-learning techniques and algorithms), the system determines the sentiment towards the change, the organization, the individual making the change itself, its testing and quality. Typically, engineers are open and engaging in the informal forums and when documenting the change in formal systems. If there is negative sentiment, the fix/change may have a higher risk. Using AI (NLP, Neural net, Large Language Models, Generative AI or other machine-learning techniques and algorithms), the system determines the sentiment towards the change and uses the weight of the component mappings to commands to apply weights to sentiment scores. Along with each component score and the composite score, individual and summary explanations can be generated for use by the organization. One objective of the system is to provide visibility to the risk(s) and defer decisions to the organization/individuals as to whether to go production with the change(s) or not.

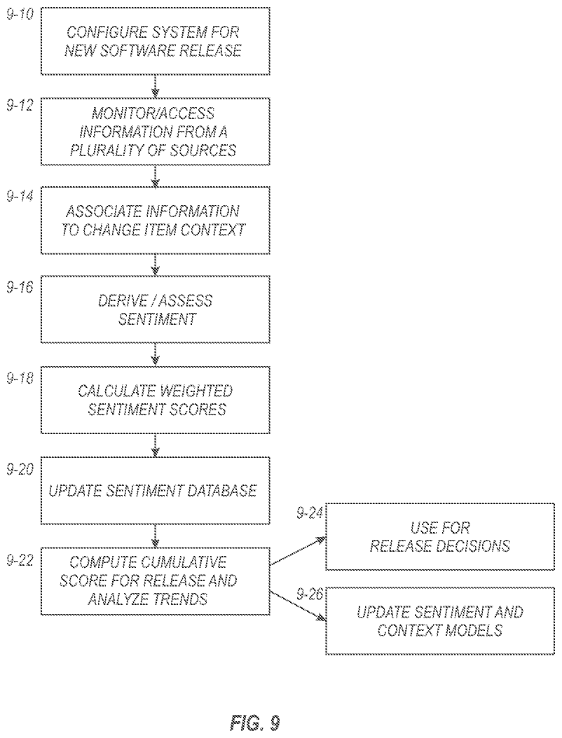

FIG. 9 is a process diagram illustrating an exemplary process for assessing the risks of an update to a software system. Other examples are also possible, as one skilled in the art would understand.

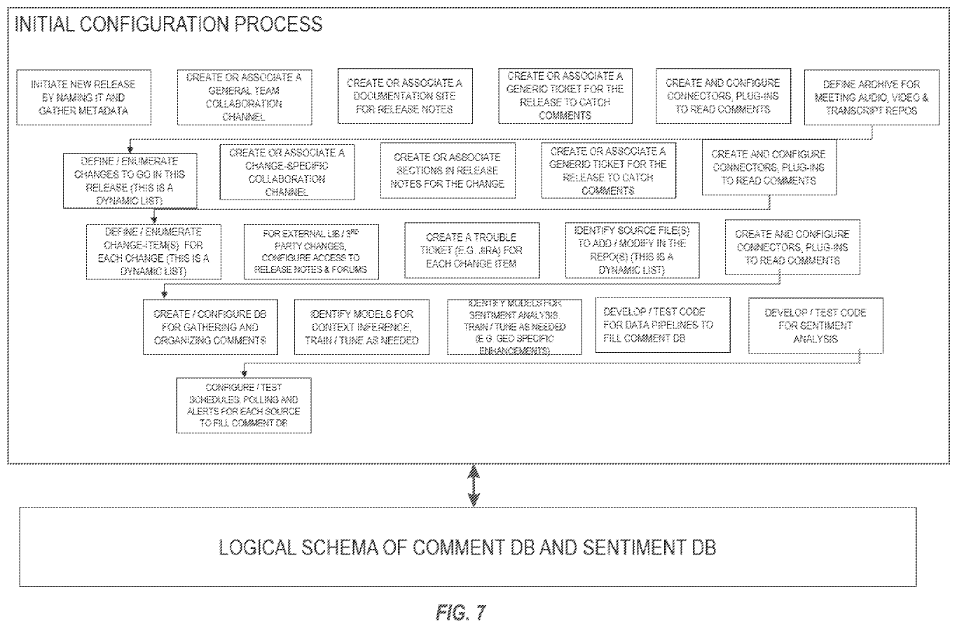

At step 9-10, the system is configured for a new software release (or change, update, etc.). One example of an initial configuration process is illustrated in FIG. 7, which shows various steps that may be taken. Following is a list of possible configuration steps, as illustrated in the example of FIG. 3. One result of the configuration process is the configuration of logical schema of a comment DB and sentiment DB.
initiate new release by naming it and gather metadata
create or associate a general team collaboration channel
create or associate a documentation site for release notes
create or associate a generic ticket for the release to catch comments
create and configure connectors, plug-ins to read comments
define archive for meeting audio, video & transcript repos
define/enumerate changes to go in this release (this can be a dynamic list)
create or associate a change-specific collaboration channel
create or associate sections in release notes for the change
create or associate a generic ticket for the release to catch comments
create and configure connectors, plug-ins to read comments
define/enumerate change-item(s) for each change (this can be a dynamic list)
for external lib/3rd party changes, configure access to release notes & forums
create a trouble ticket (e.g. Jira) for each change item
identify source file(s) to add/modify in the repo(s) (this can be a dynamic list)
create and configure connectors, plug-ins to read comments
create/configure DB for gathering and organizing comments
identify models for context inference, train/tune as needed
identify models for sentiment analysis. train/tune as needed (e.g., geo specific enhancements)
develop/test code for data pipelines to fill comment DB
develop/test code for sentiment analysis
configure/test schedules, polling and alerts for each source to fill comment DB

At step 9-12, the system monitors or accesses information from a plurality of sources, as discussed above. For example, FIGS. 3, 4, and 6 provides the following examples of information sources. Use of other sources is also possible, as one skilled in the art would understand.
release notes (ext. lib)
forums/blogs
Github comments
comments on Trello, Jira tickets
chats Slack/Team
meeting (Zoom) transcripts

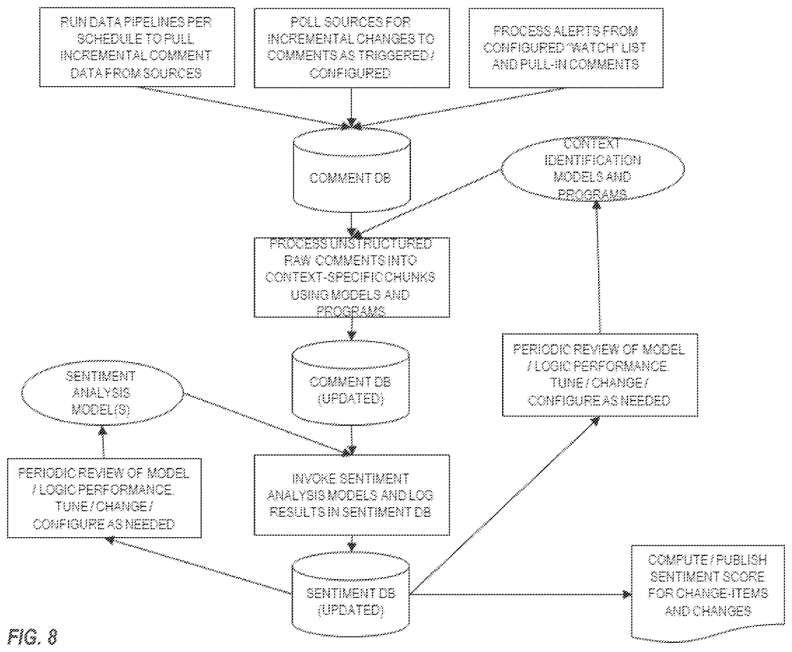

At step 9-14, the system associates collected information to a change item context. Referring to FIG. 8, the block “Process unstructured raw comments into context-specific chunks using models and program” refers to concept of providing collected information (e.g., comments) to a model(s), which along with other elements, determines context. Similarly, as illustrated in the table of FIG. 6, examples are provided of a determining context of collected information. At step 9-16, the system derives/assesses sentiment. For example, this is also illustrated in the block in FIG. 8 labeled “Invoke sentiment analysis models and log results in sentiment DB.”

At step 9-18, the system the system calculates weighted sentiment scores. For example, refer to the blocks in FIG. 3 labeled “Mappings and weights” “Compute weighted sentiment score,” as well as the mappings 218 shown in FIG. 2. Mappings and weights are used to compute a sentiment score. A weighted sentiment score is affected by the weight, as discussed in detail above. At step 9-20, the system updates the sentiment database(s).

At step 9-22, the system computes a cumulative sentiment score(s) for release and analyzes trends. FIG. 10 shows a chart of an exemplary sentiment of a release over time (from time to t0 time t14). As discussed above, the sentiment scores can be used for making decisions regarding a software release (step 9-24) as well as updating sentiment and context models (step 9-26) to improve the accuracy of scores calculated in the future.

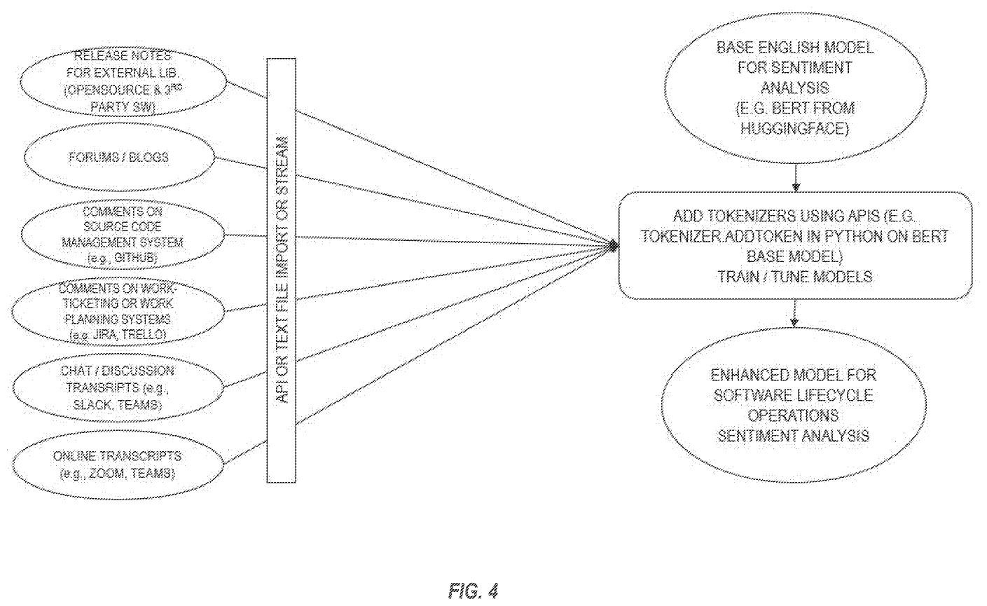

One example of the enhancements to the sentiment and context models is illustrated in the diagram of FIG. 4. As shown in FIG. 4, information is collected from a variety of sources (described above). The information may be collected via API calls, text file imports, streams, or by any other manner, as one skilled in the art would understand. In some embodiments, sentiment models can be based on an off-the-shelf commercial or open source model and enhanced by adding vocabulary, training and tuning. For example, by adding tokenizers, one can expand the vocabulary of the Bert, a commercially available model. The models can be trained/enhanced based on information collected over time. In some embodiments, the models can be augmented using various information. For example, the models can take into account the geographic location of an information source, as the meaning of terminology can vary around the world. Similarly, the models can be enhanced based on vocabulary used in the fields to which the models apply (e.g., software development, etc.). In some embodiments, the models can be enhanced based on the role of a person from which a piece of information is sourced.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, Python, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways to implement the invention.

It is also within the spirit and scope of the invention to implement in software programming or code the steps, operations, methods, routines, or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only, but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

What is claimed is:

1. A system for evaluating risks associated with a software release, the system comprising:
a processor;
a data store; and
a non-transitory computer readable medium storing instructions translatable by the processor, the instructions when translated by the processor perform:
monitoring a plurality of sources over time to collect information relating to the software release and components of the software release, wherein each of the sources are related to the software release or components of the software release;
analyzing the collected information relating to the software release to derive context of the information to determine which release, change, or change item the information is associated with;
deriving the sentiments relating to the software release or to change items included in the software release;
periodically calculating sentiment scores over time for the software release; and
monitoring the calculated sentiment scores over time to evaluate risks associated with the software release.

2. The system of claim 1, wherein the collected information is analyzed using sentiment models, the instructions further comprising:
updating and augmenting the sentiment models based on vocabulary used by software professionals;
enhancing the model to accommodate software industry specific, geographic, and cultural variations in expressing sentiments by team members; and
enhancing the model to based roles of individuals associated with the collected information.

3. The system of claim 2, enhancing the model to accommodate software industry specific, geographic, and cultural variations in expressing sentiments by team members.

4. The system of claim 1, the instructions further comprising:
enhancing the model to accommodate software industry specific, geographic, and cultural variations in expressing sentiments by team members.

5. The system of claim 4, wherein the Individuals are members of the team members in house and the larger technical community of users of OpenSource Software and 3rd Party software and services who comment on and participate in forums in house and on social media and other external sites on the Internet.

6. The system of claim 1, further comprising applying weights to modify the sentiment score to reflect its true importance indicating the severity of the impact a change item to capability/command of the Software being released to the sentiment scores.

7. The system of claim 1, wherein monitoring the calculated sentiment scores over time is used to determine release decisions.

8. A method for evaluating risks associated with a software release, the method comprising:
monitoring a plurality of sources over time to collect information relating to the software release and components of the software release, wherein each of the sources are related to the software release or components of the software release;
analyzing the collected information relating to the software release to derive context of the information to determine which release, change, or change item the information is associated with;
deriving the sentiments relating to the software release or to change items included in the software release;
periodically calculating sentiment scores over time for the software release; and
monitoring the calculated sentiment scores over time to evaluate risks associated with the software release.

9. The method of claim 8, wherein the collected information is analyzed using sentiment models, the method further comprising:
updating and augmenting the sentiment model based on vocabulary used by software professionals
enhancing the model to accommodate software industry specific, geographic, and cultural variations in expressing sentiments by team members
enhancing the model to based roles of individuals associated with the collected information.

10. The method of claim 9, enhancing the model to accommodate software industry specific, geographic, and cultural variations in expressing sentiments by team members.

11. The method of claim 9, the method further comprising:
enhancing the model to accommodate software industry specific, geographic, and cultural variations in expressing sentiments by team members.

12. The method of claim 11, wherein members of the technical community comprise team members, users of third-party tools, and open source tools.

13. The method of claim 8, further comprising applying weights to modify the sentiment score to reflect its true importance indicating the severity of the impact a change item to capability/command of the Software being released to the sentiment scores.

14. The method of claim 13, wherein monitoring the calculated sentiment scores over time is used to determine release decisions.

15. A computer program product comprising a non-transitory computer readable medium storing instructions translatable by a processor, the instructions when translated by the processor perform:
monitoring a plurality of sources over time to collect information relating to the software release and components of the software release, wherein each of the sources are related to the software release or components of the software release;
analyzing the collected information relating to the software release to derive context of the information to determine which release, change, or change item the information is associated with;
deriving the sentiments relating to the software release or to change items included in the software release;
periodically calculating sentiment scores over time for the software release; and
monitoring the calculated sentiment scores over time to evaluate risks associated with the software release.

16. The computer program product of claim 15, wherein the collected information is analyzed using sentiment models, the instructions further comprising:
updating and augmenting the sentiment model based on vocabulary used by software professionals;
enhancing the model to accommodate software industry specific, geographic, and cultural variations in expressing sentiments by team members; and
enhancing the model to based roles of individuals associated with the collected information.

17. The computer program product of claim 16, enhancing the model to accommodate software industry specific, geographic, and cultural variations in expressing sentiments by team members.

18. The computer program product of claim 15, the instructions further comprising:
enhancing the model to accommodate software industry specific, geographic, and cultural variations in expressing sentiments by team members.

19. The computer program product of claim 15, further comprising applying weights to modify the sentiment score to reflect its true importance indicating the severity of the impact a change item to capability/command of the Software being released to the sentiment scores.

20. The computer program product of claim 19, wherein monitoring the calculated sentiment scores over time is used to determine release decisions.
